(19) United States
(12) Patent Application Publication
(10) Pub. No.: US 2012/0298495 A1
(43) Pub. Date: Nov. 29, 2012

(54) KEYBOARD

(75) Inventor: Qing Zhang, Changshu (CN)

(73) Assignee: Changshu Sunrex Technology Co., Ltd.

(21) Appl. No.: 13/116,312

(22) Filed: May 26, 2011

(51) Int. Cl. H01H 13/50; H01H 13/70

(52) U.S. Cl. 200/344

(57) ABSTRACT

A large key for a keyboard includes a keyboard base, a circuit board, a keycap, an elastic member, and a linkage assembly. The linkage assembly is disposed between the keyboard base and the keycap, and includes: a first link unit having two first link levers that are spaced apart, each of the first link levers being connected between the keycap and the keyboard base; and a second link unit that has two second link levers that are spaced apart, each of the second link levers intersecting one of the first link levers and being connected between the keycap and the keyboard base. The first link unit has a first connection portion connected between and formed as one piece with the first link levers so that the two first link levers can move simultaneously.

### BACKGROUND OF THE INVENTION

1. Field of the Invention

This invention relates to a keyboard, more particularly to a large key for a keyboard that can be assembled at a reduced cost.

2. Description of the Related Art

Referring to FIGS. 1 and 2, a large key 9 in a conventional keyboard includes a base module 90, a keycap 96, and a linkage assembly 940 disposed between the base module 90 and the keycap 96. The base module 90 has a keyboard base 91, a flexible circuit board 92, an insulating film 93, and an elastic member 932 protruding from the insulating film 93.

The linkage assembly 940 includes two link units 94 and a substantially U-shaped supporting rod 943. The two link units 94 are respectively disposed at two opposite sides of the elastic member 932. Each of the link units 94 includes a first link lever 941 and a second link lever 942 that is pivotally connected to the first link lever 941 and that intersects the first link lever 941. The first link lever 941 has a first lower end 9410, two first pivot members 9411, and a first upper end 9412. The second link lever 942 has a second lower end 9420, two second pivot members 9421, and a second upper end 9422.

When assembling the large key 9, the first link lever 941 in each link unit 94 is connected pivotally to the second link lever 942 through the first pivot members 9411 and the second pivot members 9421. The first lower ends 9410 of the first link levers 941 are pivotally connected to hooks 910 on the keyboard base 91. The second lower ends 9422 of the second link levers 942 are pivotally connected to hooks 920 on the keyboard base 91. Two ends of the U-shaped supporting rod 943 are pivotally connected to hooks 930 on the keyboard base 91. A rod portion of the U-shaped supporting rod 943, and the upper ends 9412, 9422 of the first and second link levers 941, 942 are all connected pivotally to the keycap 96.

When a force is applied to the keycap 96, which pushes the elastic member 932 to contact a circuit on the flexible circuit board 92, the flexible circuit board 92 produces an input signal. When no force is applied, a restoring force of the elastic member 932 returns the keycap 96 to an original position.

However, because the large key 9 includes the U-shaped supporting rod 943, labor and material costs for fabricating the conventional keyboard are relatively high.

### SUMMARY OF THE INVENTION

Therefore, an object of the present invention is to provide a large key for a keyboard that can overcome the aforesaid drawback associated with the prior art.

Accordingly, a large key for a keyboard of this invention comprises:

a keyboard base;

a circuit board disposed on the keyboard base;

a keycap;

an elastic member disposed between the circuit board and the keycap; and

a linkage assembly disposed between the keyboard base and the keycap and including:

a first link unit having two first link levers that are spaced apart, each of the first link levers being connected between the keycap and the keyboard base; and

a second link unit that has two second link levers that are spaced apart, each of the second link levers intersecting one of the first link levers and being connected between the keycap and the keyboard base;

wherein the first link unit has a first connection portion connected between and formed as one piece with the first link levers so that the two first link levers can move simultaneously.

### BRIEF DESCRIPTION OF THE DRAWINGS

Other features and advantages of the present invention will become apparent in the following detailed description of the preferred embodiments of the invention, with reference to the accompanying drawings, in which:

FIG. 1 is an exploded perspective view of a large key in a conventional keyboard;

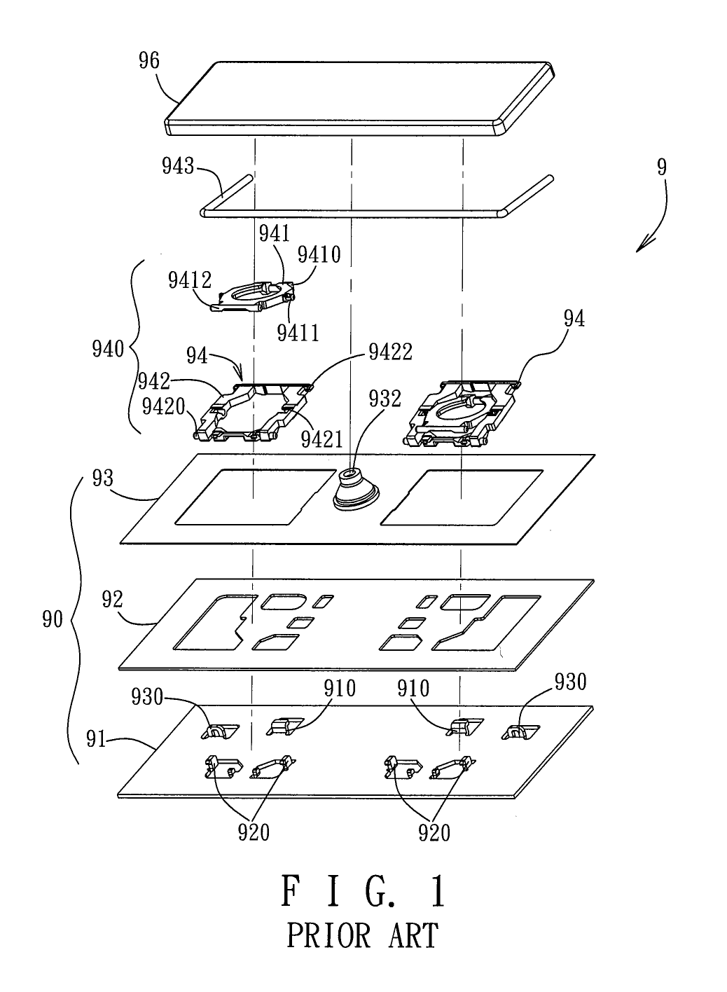

FIG. 2 is a cross-sectional view of the large key of FIG. 1 in an assembled state;

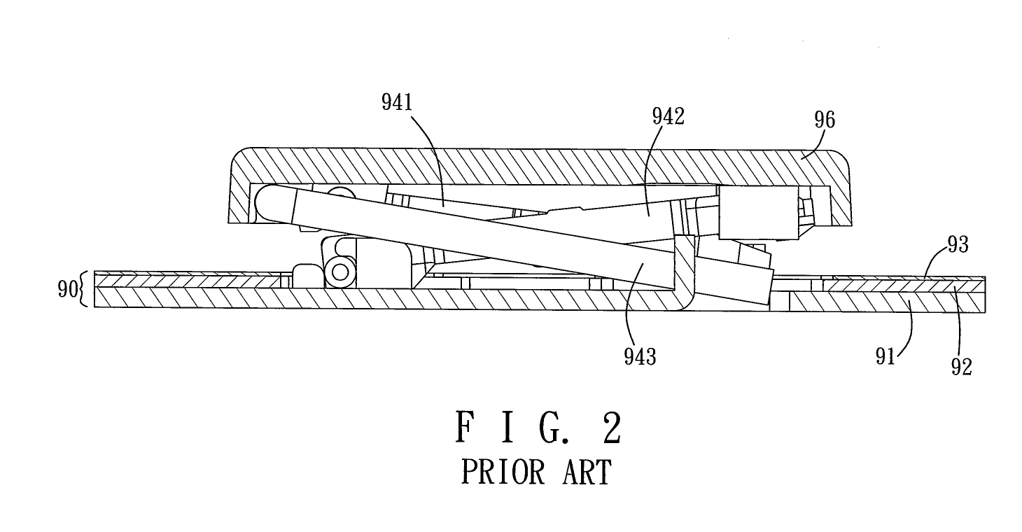

FIG. 3 is an exploded perspective view of the first preferred embodiment of a large key for a keyboard according to the present invention;

FIG. 4 is a cross-sectional view of the large key of FIG. 3 in an assembled state;

FIG. 5 is an exploded perspective view of the second preferred embodiment of a large key for a keyboard according to the present invention;

FIG. 6 is a cross-sectional view of the large key of FIG. 5 in an assembled state;

FIG. 7 is an exploded perspective view of the third preferred embodiment of a large key for a keyboard according to the present invention; and

FIG. 8 is a cross-sectional view of the large key of FIG. 7 in an assembled state.

### DETAILED DESCRIPTION OF THE PREFERRED EMBODIMENTS

Before the present invention is described in greater detail with reference to the accompanying preferred embodiments, it should be noted herein that like elements are denoted by the same reference numerals throughout the disclosure.

In this specification, the term “large key” means a press key that covers several small key fields in a keyboard.

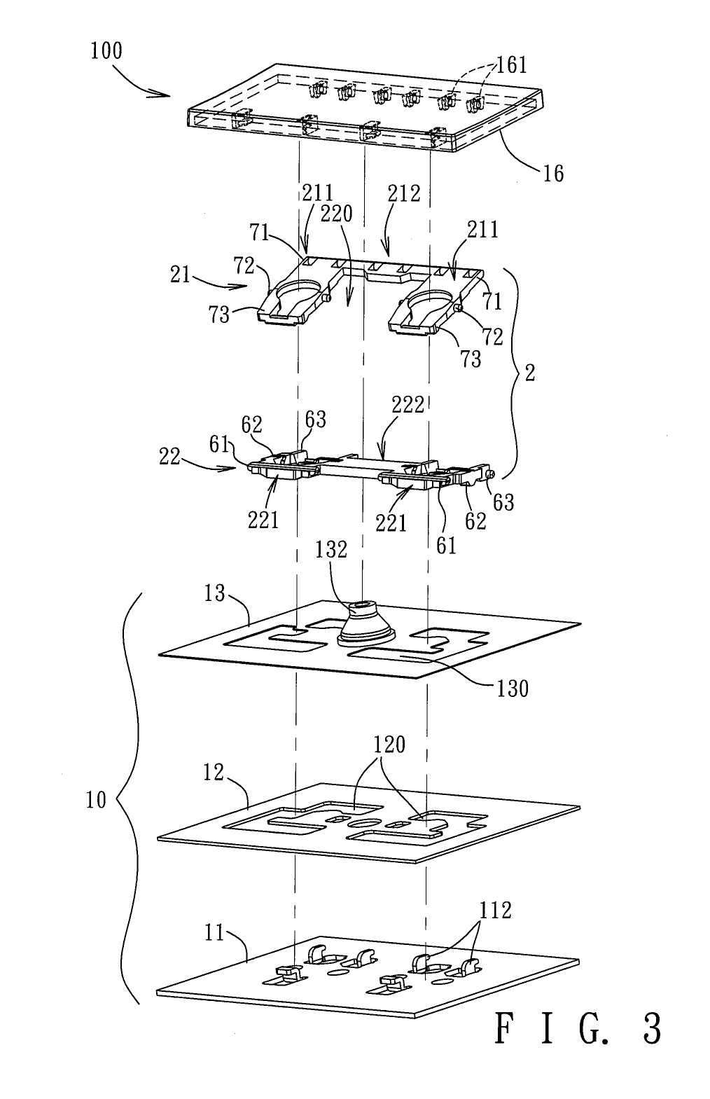

Referring to FIG. 3, the first preferred embodiment of a large key 100 for a keyboard according to this invention includes a base module 10, a keycap 16 and a linkage assembly 2 disposed between the base module 10 and the keycap 16.

The base module 10 includes a keyboard base 11, a circuit board 12, and an insulating film 13. The keyboard base 11 has a plurality of hooks 112 formed thereon. The circuit board 12 is disposed on the keyboard base 11. The insulating film 13 is disposed on the circuit board 12, and has an elastic member 132 disposed thereon. The elastic member 132 protrudes from a central portion of the insulating film 13, and is disposed between the circuit board 12 and the keycap 16. The circuit board 12 has through holes 120, and the insulating film 13 has through holes 130 . The keycap 16 has a plurality of hooks 161 formed on a lower surface thereof.

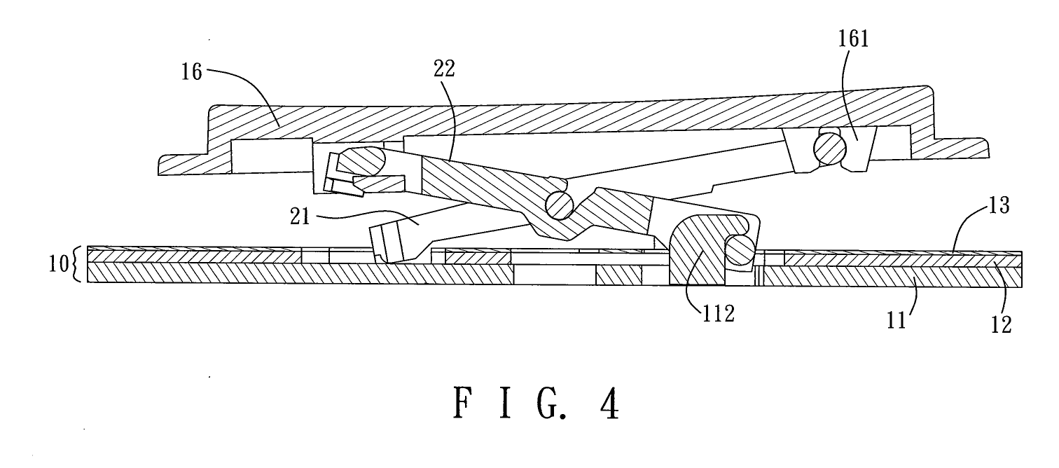

Referring to FIGS. 3 and 4, in the first preferred embodiment, the linkage assembly 2 is disposed between the keyboard base 11 and the keycap 16, and has a first link unit 21 and a second link unit 22 intersecting the first link unit 21. The first link unit 21 has two first link levers 211 that are spaced apart, and a first connection portion 212. Each of the first link levers 211 is connected between the keycap 16 and the keyboard base 11. The first connection portion 212 is connected between and is formed as one piece with the first link levers 211 so that the two first link levers 211 can move simultaneously. The second link unit 22 has two second link levers 221 that are spaced apart, and a second connection portion 222. Each of the second link levers 221 intersects one of the first link levers 211, and is connected between the keycap 16 and the keyboard base 11. The second connection portion 222 is connected between and is formed as one piece with the second link levers 221 so that the two second link levers 221 can move simultaneously.

Each of the first link levers 211 has an upper end 71 connected pivotally to the respective hooks 161 of the keycap 16, a lower end 73 connected pivotally to the respective hook 112 of the keyboard base 11 through the respective through holes 120, 130, and two opposite sides 72 interconnecting the upper and lower ends 71, 73. Each of the second link levers 221 has an upper end 61 connected pivotally to the respective hooks 161 of the keycap 16, a lower end 63 connected pivotally to the respective hooks 112 of the keyboard base 11 through the respective through holes 120, 130, and two opposite sides 62 interconnecting the upper and lower ends 61, 63. The first link levers 211 are connected pivotally and respectively to the second link levers 221 at locations midway of the upper and lower ends 71, 73, 61, 63 of the first and second link levers 211, 221.

The first connection portion 212 is located between the upper ends 71 of the first link levers 211, and is connected pivotally to the respective hooks 161 of the keycap 16. The first link levers 211 define a gap 220 therebetween below the first connection portion 212, and the elastic member 132 is disposed in the gap 220.

The second connection portion 222 extends across the gap 220 above the elastic member 132, and is connected to the second link levers 221 substantially at locations midway of the upper and lower ends 61, 63 of the second link levers 221.

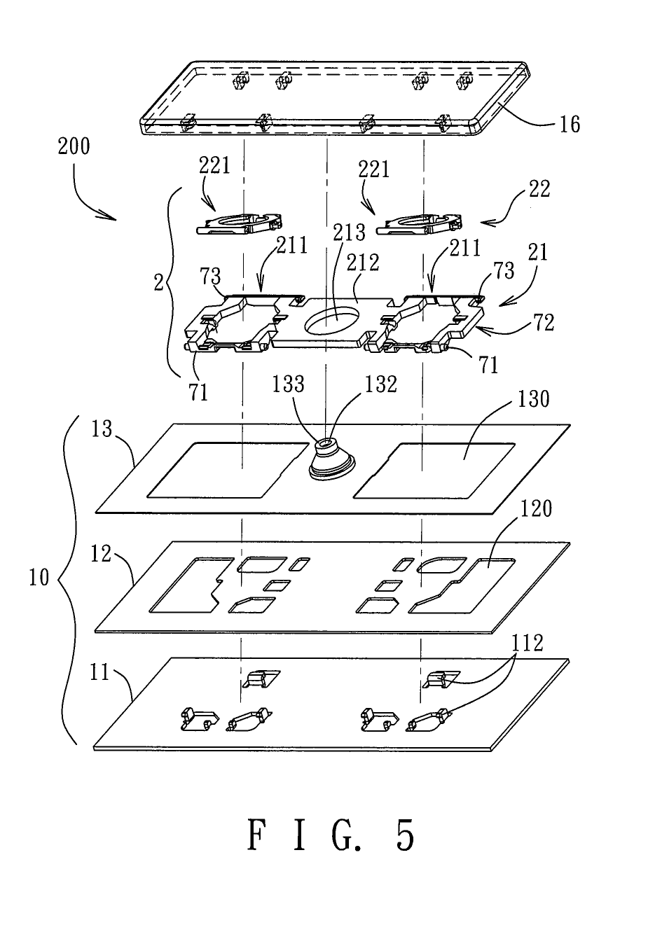

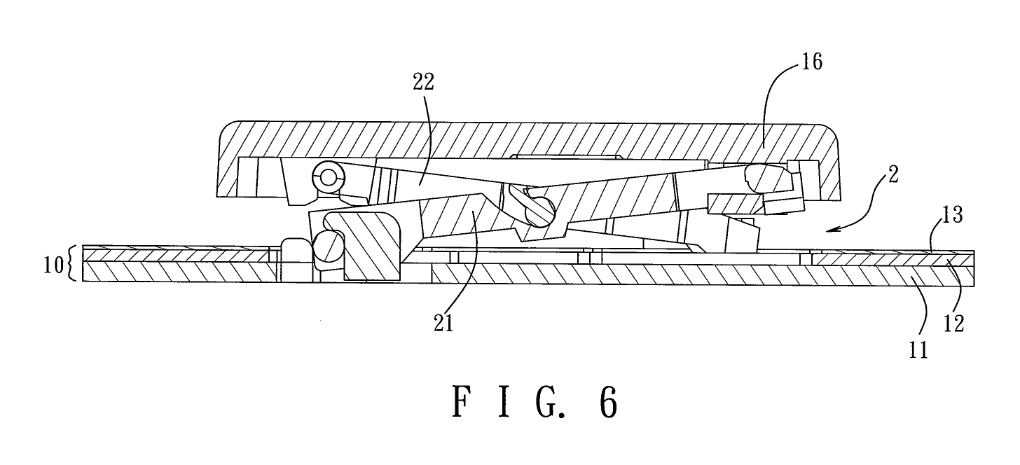

FIGS. 5 and 6 illustrate the second preferred embodiment of a large key 200 for a keyboard according to the present invention. The second preferred embodiment differs from the first preferred embodiment in the structure of the linkage assembly 2. In the linkage assembly 2, no connection portion is provided to interconnect the second link levers 221, and the first connection portion 212 is connected to the first link levers 211 at locations midway of the upper and lower ends 71, 73 of the first link levers 211. The first connection portion 212 is formed with a middle opening 213, and the elastic member 132 has an upper end 133 extending through the middle opening 213.

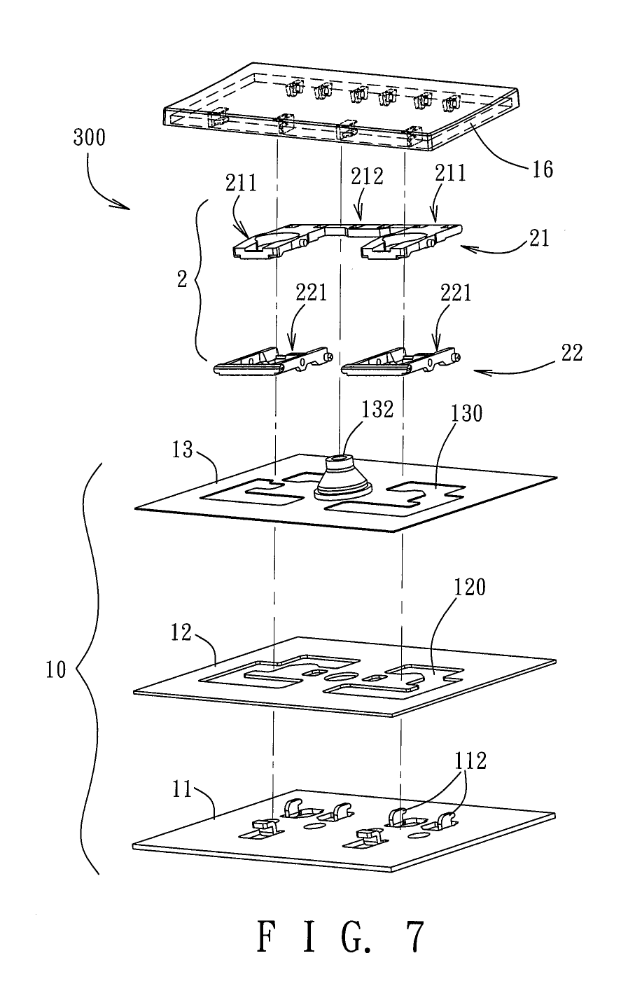

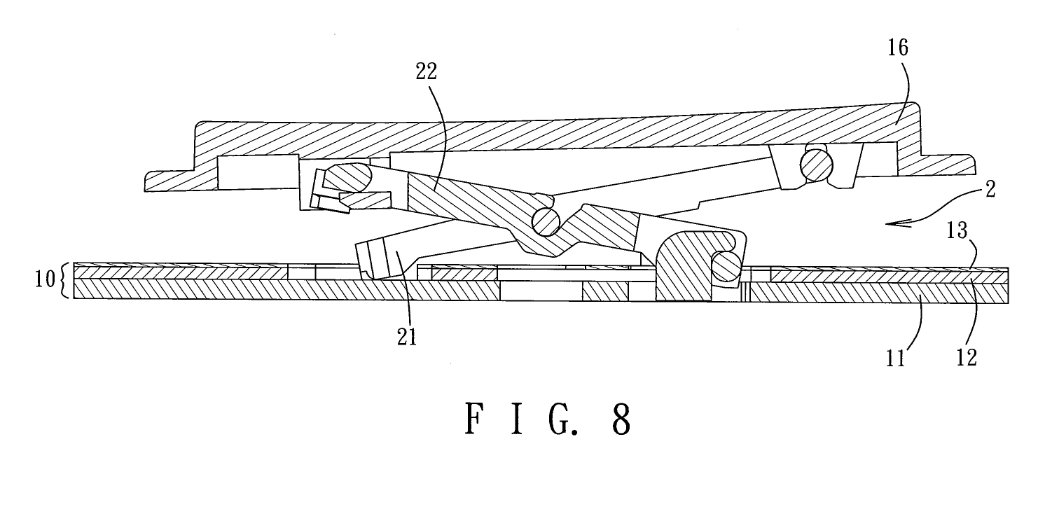

FIGS. 7 and 8 illustrate the third preferred embodiment of a large key 300 for a keyboard according to the present invention. The third preferred embodiment differs from the first preferred embodiment in that no connect ion portion interconnects the second link levers 221.

While the present invention has been described in connection with what are considered the most practical and preferred embodiments, it is understood that this invention is not limited to the disclosed embodiments but is intended to cover various arrangements included within the spirit and scope of the broadest interpretations and equivalent arrangements.

What is claimed is:

1. A large key for a keyboard, comprising:
a keyboard base;
a circuit board disposed on said keyboard base;
a keycap;
an elastic member disposed between said circuit board and said keycap; and
a linkage assembly disposed between said keyboard base and said keycap and including:
a first link unit having two first link levers that are spaced apart, each of said first link levers being connected between said keycap and said keyboard base; and
a second link unit that has two second link levers that are spaced apart, each of said second link levers intersecting one of said first link levers and being connected between said keycap and said keyboard base;
wherein said first link unit has a first connection portion connected between and formed as one piece with said first link levers so that said two first link levers can move simultaneously.

2. The large key for a keyboard of claim 1, wherein each of said first and second link levers has an upper end connected pivotally to said keycap, a lower end connected pivotally to said keyboard base, and two opposite sides interconnecting said upper and lower ends, said first link levers being connected pivotally and respectively to said second link levers substantially at locations midway between said upper and lower ends of said first and second link levers.

3. The large key for a keyboard of claim 2, wherein said first connection portion is located between said upper ends of said first link levers, and is connected pivotally to said keycap, said first link levers defining a gap therebetween below said first connection portion, said elastic member being disposed in said gap.

4. The large key for a keyboard of claim 3, wherein said second link unit has a second connection portion connected between and formed as one piece with said second link levers so that said two second link levers can be moved simultaneously, said second connection portion extending across said gap above said elastic member.

5. The large key for a keyboard of claim 4, wherein said second connection portion is connected to said second link levers at locations midway of said upper and lower ends of said second link levers.

6. The large key for a keyboard of claim 2, wherein said first connection portion is connected to said first link levers at locations midway of said upper and lower ends of said first link levers, and is formed with a middle opening, said elastic member having
